(19) United States
(12) Patent Application Publication
(10) Pub. No.: US 2003/0211263 A1
(43) Pub. Date: Nov. 13, 2003

(54) Optically reflective sleeving and associated methods of use

(76) Inventors: William E. Dermody III, Sparta, NJ (US); William E. Dermody JR., Sparta, NJ (US); William E. Dermody IV, Sparta, NJ (US); Green Victoria, Sparta, NJ (US)

Correspondence Address: LAMORTE & ASSOCIATES P.C., P.O. BOX 434, YARDLEY, PA, 19067, US

(21) Appl. No.: 10/461,405

(22) Filed: Jun. 13, 2003

Related U.S. Application Data
(63) Continuation-in-part of application No. 09/431,060, filed on Nov. 1, 1999, now abandoned.

(51) Int. Cl. B32B 1/08

(52) U.S. Cl. 428/36.3

(57) ABSTRACT

A reflective protective sleeve structure having a tubular a tubular structure, wherein the protective sleeve defines an internal surface and a reflective exterior surface. The sleeve is made from plastic monofilaments that are braided together. All the monofilaments are uniformly made of plastic. However, the plastic used to fabricate at least most of the monofilaments in the sleeve are fabricated from optically reflective plastic. Accordingly, the protective sleeve embodies optically reflective properties that make that sleeving highly visible at night when in range of the headlights of an approaching vehicle.

### RELATED APPLICATIONS

This application is a continuation-in-part of U.S. patent application Ser. No. 09/431,060, entitled OPTICALLY REFLECTIVE SLEEVING AND ASSOCIATED METHODS OF USE, which was filed Nov. 1, 1999.

### BACKGROUND OF THE INVENTION

1. Field of the Invention

The present invention relates to sleeving products commonly used to bundle cables, protect hoses and organize wires. More particularly, the present invention relates to sleeving products made from specialty materials that provide the sleeving products with useful optical properties.

2. Description of the Prior Art

Protective sleeving is an auxiliary sheathing structure that can be passed over wires, tubing, cable or any other elongated structure. When protective sheathing is placed over tubing, cables or like structures, its primary purpose is to protect those structures from damage due to contact abrasion and other wear. When protective sleeving is placed over loose wires, its primary purpose is to bind the wires into an organized cable while protecting those wires from damage.

In the prior art, there are many different types of protective sleeving. A common type of protective sleeving is expandable sleeving. Expandable sleeving is made of braided strands of material. When braided sleeving is compressed, its diameter expands. Likewise, when braided sleeving experiences tension, the diameter of the braided sleeving contracts. Accordingly, braided sleeving is very useful in protecting segments of wire and tubing that may vary in diameter from point to point.

The material used to produce expandable sleeving varies with technical requirements. In applications where the expandable sleeve will experience extreme conditions, the expandable sleeve is often made from braided metal wire, such as stainless steel. In applications where the expandable sleeve experiences normal conditions, the expandable sleeves are most commonly fabricated from strands of polymer filaments, such as polyester yarn, polyethylene terephthalate, Teflon®, Ryton®, Nylon® and the like.

Since protective sleeving acts as the cover to many elongated structures, in many applications the protective sleeving is the only part of the structure that is visible to an observer. Accordingly, in an attempt to enhance the appearance of many assemblies, the aesthetics of the protective sleeving has been altered. For example, protective sleeving made from polymer filaments can be fabricated in any color of the spectrum by adding dye to the polymer being used. Protective sleeving made from metal wire can be chromed, anodized or otherwise colored for aesthetic purposes. Such techniques are exemplified in U.S. Pat. No. 5,639,527 to Hurwitz, entitled, Braided Wire Sheathing Having Chrome Appearance.

An example of an assembly where the protective sleeving is highly visible is a bicycle. Many bicycles have brake cables. The brake cables are often covered with a protective sleeving to prevent damage to the brake cables. The protective sleeving is visible to any person viewing the bicycle. As such, the aesthetics of the protective sleeving are important to the overall appearance of the bicycle.

It is known to make protective sleeving for assembles, such as bicycles, from different color material. However, it is a purpose of the present invention to provide protective sleeving that is not only aesthetically pleasing but also provides reflective optical properties. Consequently, not only is the protective sleeving aesthetically pleasing, it acts a reflector at night, thereby providing safety to the assembly and greatly increasing the night time aesthetics of the assembly.

### SUMMARY OF THE INVENTION

The present invention is a reflective protective sleeve. The protective sleeve is formed into a tubular structure, wherein the protective sleeve defines an internal surface and an exterior surface. The sleeve is made from plastic monofilaments that are braided together. All the monofilaments are uniformly made of plastic. However, the plastic used to fabricate at least most of the monofilaments in the sleeve are fabricated from optically reflective plastic. Accordingly, the protective sleeve embodies optically reflective properties that makes that sleeving highly visible at night when in range of the headlights of an approaching vehicle.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is perspective view of an exemplary embodiment of a reflective sleeve shown covering the brake cables of a bicycle;

FIG. 2 is perspective view of a section of a bicycle brake cable covered with a segment of a reflective protective sleeving; and

FIG. 3 is a perspective view of an embodiment of the present invention having a closable seam.

### DETAILED DESCRIPTION OF THE INVENTION

Although the present invention protective sleeving can be used to protect most any cable, tube or wire bundle in a wide variety of assemblies, the present invention is particularly well suited for use in covering the brake cables of a bicycle. Accordingly, by way of example, the present invention device will be described in an application where the device is used to cover the brake cables of a bicycle. The application described is merely exemplary and should not be considered a limitation to the applications of the present invention protective sleeving device.

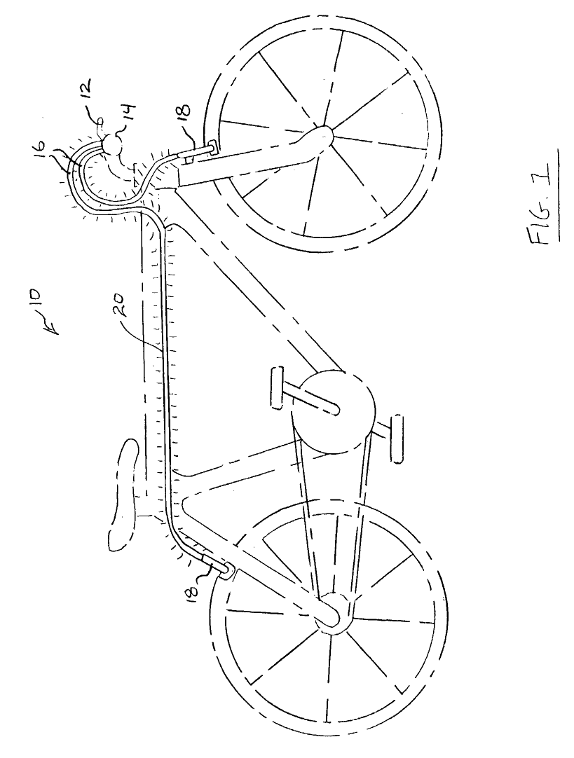

Referring to FIG. 1, a bicycle 10 is shown. The bicycle 10 has a hand brake system. The hand brake system uses levers 12 on the handlebars 14 to manipulate wire brake cables 16. The wire brake cables 16 extend to the clamp brakes 18 on the wheels of the bicycle 10. Each of the brake cables 16 contain a metal cable surrounded by a plastic sheathing. When the levers 12 on the handlebars 14 are manipulated, the metal wire moves in relation to its plastic sheathing, thereby causing the clamp brakes 18 to operate. The present invention protective sleeving 20 covers the cable sheathing, thereby providing an added layer of protection from contact damage.

The protective sleeving 20 is made of strands of optically reflective plastic. There are many compositions of optically reflective plastic. Optically reflective plastics are plastics that reflect, at random angles of reflection, a high percentage of light energy that strikes the plastic. Compositions of optically reflective plastic are used in the formation of automobile and bicycle reflectors. Such reflectors reflect light of headlights at night, thereby making the reflectors visibly noticeable to on coming traffic. Any of the compositions of optically reflective light plastic that is used in the field of reflector plastic production can be adapted for use in the present invention.

In the embodiment of FIG. 1, the stands used to make the protective sleeving 20 are completely and uniformly molded from the optically reflective plastic. Accordingly, when a light strikes the bicycle at night, the light is reflected by the material of the protective sleeving 20. This causes the reflective sleeving 20 to appear to glow.

The protective sleeving 20 extends across a significant portion of the frame of the bicycle 10. Accordingly, at night, the protective sleeving 20 can more than double the reflective surfaces of a normal bicycle. Furthermore, reflectors are commonly mounted to the front, rear and pedals of a bicycle. The reflective protective sleeving 20 can be viewed from the front, rear and sides of the bicycle, thereby greatly increasing the visibility of the bicycle 10, especially when viewed from the side.

The presence of the reflective protective sleeving 20 on the bicycle's brake cables 16 also enables a person to visualize the length of the bicycle 10 as it passes in the night. This provides automobile drivers with a greater perception of the size and location of the bicycle 10, thereby reducing the chances of an accident.

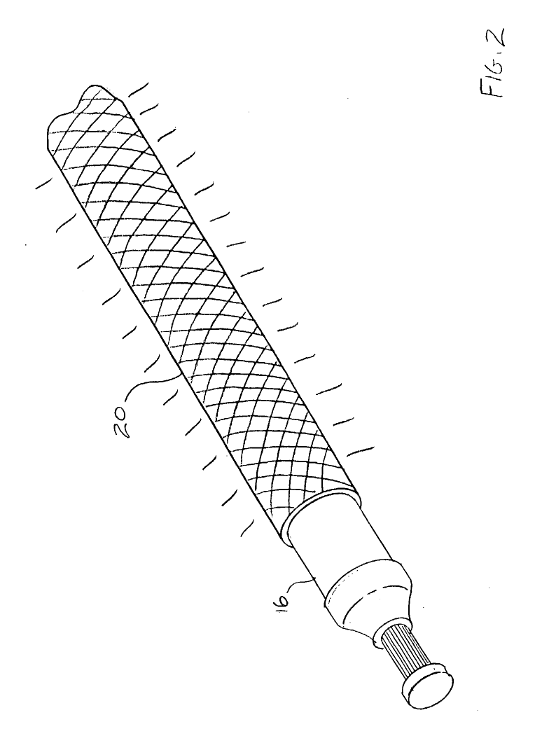

Referring to FIG. 2, a first embodiment of the protective sleeving 20 is shown. In this embodiment, the protective sleeving 20 is made from braided plastic monofilaments. Each monofilament has a diameter of between 0.005 inches and 0.030 inches and is uniformly composed of plastic. Either all of the monofilaments or at least most of the monofilaments are uniformly and entirely fabricated from optically reflective plastic. The monofilaments that are fabricated from the optically reflective plastic are herein referred to as optically reflective monofilaments.

As was previously explained, the plastic compositions used in creating the optically reflective monofilaments can be any of the reflective plastic materials currently used in the production of standard bicycle light reflectors. Extenders and plasticizers can be added to the plastic composition, prior to forming the monofilaments, in order to increase the elasticity of the optically reflective monofilaments so that the flexibility of the optically reflective monofilaments is close to that of the standard braiding monofilaments. The addition of such extenders and plasticizers do not have significant adverse effects on the optically reflective properties of the plastic.

As is known in the prior art, optically reflective plastic can be made into numerous colors. The most common colors of reflective material are red, yellow and white. As such, it should be understood that the optically reflective monofilaments used in the braiding of the protective sleeving 20 can be made in numerous colors. Accordingly, a person can select the color of the protective sleeving 20. In this manner, a color can be selected that will not clash with the colors of the bicycle when viewed during the day.

The optically reflective monofilaments and the standard monofilaments, if any, are braided in a traditional manner to make the reflective protective sleeving 20. To apply the reflective protective sleeving 20 to a bicycle, a segment of protective sleeving 20 is cut to a length that matches that of a particular brake cable. The brake cable 16 is then disconnected from the bicycle at at least one end. The protective sleeving 20 is advanced over the brake cable 16 until the protective sleeving 20 extends along the length of the brake cable 16. The brake cable 16 is then reattached to the bicycle.

It is understood that the illustration of a bicycle is merely exemplary and that the reflective protective sleeving can be applied over most any cable, tube or gathering of wires. In certain application, it may not be practical to disconnect a tube, cable or group of wires in order to install the reflective protective sleeving. In such scenarios, the reflective protecting sleeving can be fabricated with a seam.

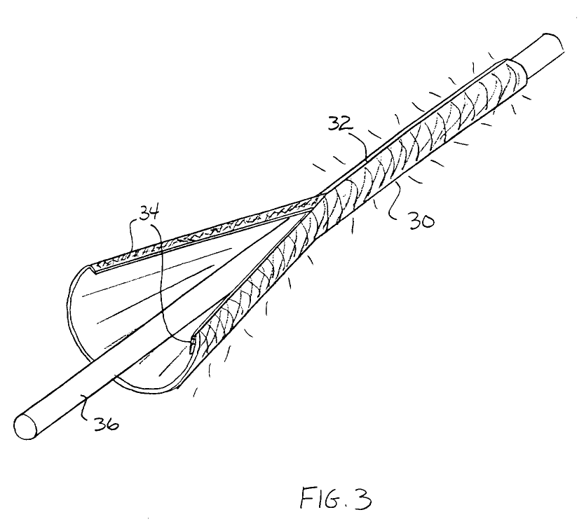

Referring to FIG. 3, a segment of reflective protective sleeving 30 is shown. In this embodiment, the protective sleeving 30 has a seam 32 that runs the length of the protective sleeving 30. Hook and loop fastening material 34 is positioned adjacent the seam 32. The hook and loop fastening material 34 enables the reflective protective sleeving 30 to be selectively closed around an elongated structure 36 without having to disturb the elongated structure 36. The hook and loop fastening material 34 is not present on the exterior of the protective sleeving 30 when the protective sleeving 30 is closed. Consequently, the reflective properties of the protective sleeving 30 are undisturbed by the seam 32 or the hook and loop material 34.

It will be understood that the specifics of the present invention described above illustrate only exemplary embodiments of the present invention. A person skilled in the art can therefore make numerous alterations and modifications to the shown embodiments utilizing functionally equivalent components to those shown and described. Furthermore, features of the different embodiments can be mixed and matched in ways not specifically described. All such modifications are intended to be included within the scope of the present invention as defined by the appended claims.

What is claimed is:

1. A braided protective sleeve device, comprising:
a plurality of plastic monofilaments braided into a tubular structure, wherein each of said plurality of plastic monofilaments is uniformly fabricated from a plastic and at least some of said plurality of plastic monofilaments are fabricated from plastic having optical reflective properties.

2. The device according to claim 1, wherein all of said plurality of plastic monofilaments are uniformly fabricated from plastic having optical reflective properties.

3. The device according to claim 1, further including a selectively closeable seam extending along said tubular structure for enabling said tubular structure to be opened along its length.

4. The device according to claim 1, wherein at least some of said plurality of plastic monofilaments are coated with an optically reflective plastic.

5. A method of adding a reflective cover to a brake cable on a bicycle, comprising the steps of:
providing a tubular protective sleeve, comprised of braided plastic monofilaments, wherein each of said plastic monofilaments is uniformly fabricated from plastic and where at least some of said plastic monofilaments are uniformly fabricated from optically reflective plastic;
placing the brake cable within said tubular protective sleeve, wherein said protective sleeve surrounds the brake cable.

6. The method according to claim 5, wherein all of said plurality of plastic monofilaments are uniformly fabricated from optically reflective plastic.

7. The method according to claim 5, wherein said at least some of said plurality of plastic monofilaments are coated with an optically reflective plastic.

8. On a bicycle having a hand brake system, an improved brake cable having a protective sleeving comprised of braided plastic monofilaments, wherein at least some of said plastic monofilaments are uniformly fabricated from optically reflective plastic.

9. The brake cable according to claim 8, wherein all of said monofilaments in said protective sleeving are uniformly fabricated from optically reflective plastic.
